(19) United States
(12) Patent Application Publication
(10) Pub. No.: US 2015/0127748 A1
(43) Pub. Date: May 7, 2015

(54) RECOMMENDATIONS FOR ENHANCED CONTENT IN SOCIAL POSTS

(71) Applicant: Kirill Buryak, Sunnyvale, CA (US)

(72) Inventor: Kirill Buryak, Sunnyvale, CA (US)

(73) Assignee: Google Inc., Mountain View, CA (US)

(21) Appl. No.: 13/447,061

(22) Filed: Apr. 13, 2012

(51) Int. Cl. H04L 12/58; G06F 3/048; G06F 17/30; G06F 15/16

(52) U.S. Cl. CPC H04L 51/32; G06F 17/30867
USPC 709/206; 715/716; 715/751

(57) ABSTRACT

Methods, systems, and computer programs are presented for creating recommendations to add enhanced content to a post being created in a social network. One method includes an operation for detecting, using one or more computing devices, user input for a social post before the social post is submitted on the social network. The user input is analyzed, using the one or more computing devices, as is being entered to determine relevant content. Further, the method includes another operation for providing for display, using the one or more computing devices, the content recommendations, with the option to select one or more items on the content. If any of the recommendations are selected, the social post is provided for display, using the one or more computing devices, with the user input and with the selected recommendations.

### BACKGROUND

1. Field

The present embodiments relate to methods for improving user satisfaction, and more particularly, methods, computer programs, and systems for including enhanced content in a post being created in a social network.

2. Description of the Related Art

The communication capability provided by social networks has opened new forms of communication in today's society, making easier for people to communicate with each other. Users of the social network want to share, not only textual messages, but also other items such as photos and photo albums, videos created by the person making a post, videos available on the internet, music, computer files, etc.

Users want to make their posts stand out by including relevant information associated with the post. For example, a user that visited a restaurant may want to add a photo taken at the restaurant, as well as information about the restaurant, such as the webpage of the restaurant or a ratings page for the restaurant. However, the process for finding additional relevant content to be added to the post is often cumbersome and lengthy, requiring the user to perform searches to find related items for inclusion in the post.

It is in this context that embodiments arise.

### SUMMARY

Embodiments of the disclosure provide methods, systems, and computer programs for creating recommendations to add enhanced content to a post being created in a social network. It should be appreciated that the present embodiments can be implemented in numerous ways, such as a process, an apparatus, a system, a device or a method on a computer readable medium. Several embodiments are described below.

In one embodiment, a method includes an operation for detecting, using one or more computing devices, user input for a social post before the social post is submitted on the social network. The user input is analyzed, using the one or more computing devices, as it is being entered, to determine relevant content. Further, the method includes another operation for providing for display, using the one or more computing devices, the content recommendations, with the option to select one or more items on the content. If any of the recommendations are selected, the social post is provided for display, using the one or more computing devices, with the user input and with the selected recommendations.

In another embodiment, a computer program embedded in a non-transitory computer-readable storage medium, when executed by one or more processors, if provided for creating a social post in a social network. The computer program includes program instructions for detecting user input for a social post before the social post is submitted on the social network, and program instructions for analyzing the user input, as the user input is being entered, to determine multimedia content that is relevant to the user input. Further, the computer program includes program instructions for providing for display the multimedia content with an option to select one or more items in the multimedia content, and program instructions for receiving a selection of items in the multimedia content. The social post is provided for display, with the social post having the user input and the selected items.

In yet another embodiment, a method for creating a social post in a social network includes an operation for detecting, using one or more computing devices, user input for a social post before the social post is submitted on the social network, the user input including keywords having topical meaning. The keywords are analyzed, using the one or more computing devices, as the user input is being entered to determine content that is relevant to the keywords. Furthermore, the method includes another operation for providing for display, using the one or more computing devices, the content with an option to select one or more items in the content. After receiving, using the one or more computing devices, a selection of items in the content, the social post is provided with the user input and the selected items.

Other aspects will become apparent from the following detailed description, taken in conjunction with the accompanying drawings.

### BRIEF DESCRIPTION OF THE DRAWINGS

The embodiments may best be understood by reference to the following description taken in conjunction with the accompanying drawings.

FIG. 1 is a person's web page for interfacing with a social network, according to one embodiment.

FIG. 2 is a user interface for entering a post on a social network, according to one embodiment.

FIG. 3 illustrates a social post with enhanced content, according to one embodiment.

FIG. 4 shows recommendations based on a selected keyword, according to one embodiment.

FIG. 5 is a web page for entering user profile attributes, according to one embodiment.

FIG. 6 illustrates a method for evaluating an article for recommendation based on cluster information, according to one embodiment.

FIG. 7 illustrates the process for generating recommendations, according to one embodiment.

FIG. 8 provides an architecture of a system that may utilize embodiments described herein.

FIG. 9 shows a flowchart illustrating a process for creating a social post in a social network, in accordance with one embodiment.

FIG. 10 is a schematic diagram of a computer system for implementing embodiments described herein.

### DETAILED DESCRIPTION

The following embodiments describe methods, systems, and computer programs for creating recommendations to add enhanced content to a post being created in a social network. One of the ways to increase user engagement in social networks is to make the creation of social posts easier and the social posts richer in content. Embodiments provide methods to enhance user engagement by helping the users to create and annotate social posts with a variety of related content, including web references, online videos and music, references to other relevant posts, news articles, etc.

It will be apparent, that the present embodiments may be practiced without some or all of these specific details. In other instances, well known process operations have not been described in detail in order not to unnecessarily obscure the present embodiments.

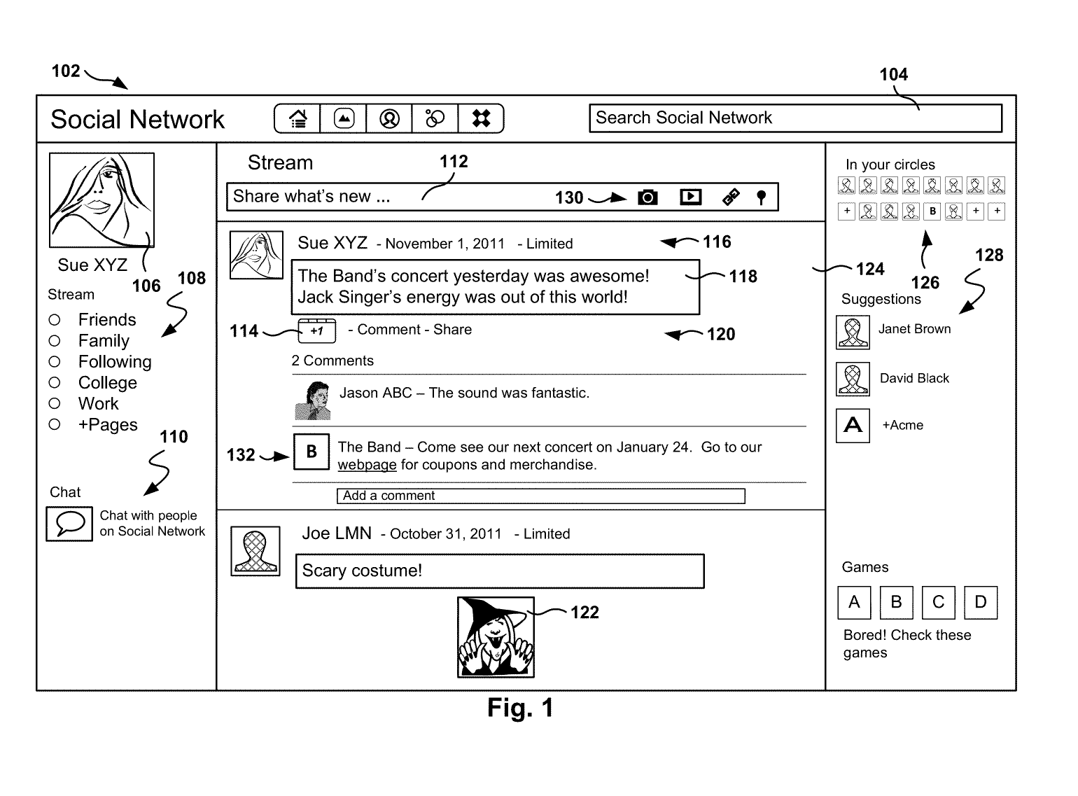

FIG. 1 is a person's web page for interfacing with a social network, according to one embodiment. For example, the person is shown logged into her user account. In one embodiment, posts received or created by a user are referred to as the content of a stream in the social network. Page 102 is an example snapshot of a page for viewing a person's stream in the social network, and search field 104 is an input area for searching the social network or other network content.

In one embodiment, the stream is presented in a middle panel of page 102. Input box 112 enables the person to add new posts in the social network. When the person enters a new post, the person is able to select the destination, e.g., the target audience for the post. The target audience could be the complete social network (e.g., a public post), a person, or one or more groups defined by the person. The post may include text or some other multimedia items. If the user clicks on one of the multimedia icons 130, a dialog box will be presented to the user to add a photo, a video, a link, a location, a song, a file, etc.

In one embodiment, the groups defined by the person are referred to as “circles,” but other configurations for defining groups are also possible. Examples include various graphically designed interfaces or text based lists, dialog boxes, pull downs, radio buttons, and other interfaces defined from a combinations of graphical elements, text, images, pictures, combinations thereof, etc. In one embodiment, the post may be a text message, a photo, a video, a link to a webpage, or a location of the person. Thus, the content and form of the post should be broadly construed to include any data that can be presented, displayed, listened to, interfaced with, received, sent, shared, approved, or disapproved, etc.

In one embodiment, the stream includes posts added by the person, by others socially linked to the person, or by an entity that the person has chosen to follow (e.g., be linked with/to in the social network). In one embodiment, an entity may be restricted from posting to a person's stream, unless the person has established a social link with the entity beforehand, e.g., the person has chosen to follow the entity.

In one embodiment, each post 124 may include information 116 about the author, the timestamp of the post, and the scope of the post (e.g., public, limited, etc.). Example post 124 may include a text message 118 entered by person “Sue XYZ,” but other types of posts are possible, such as photo 122, a video, a link, data, a news article, etc. The social network provides options 120 to respond to the post, such as providing an endorsement of the post, adding a comment 132 to the post, or sharing the post with others.

As used herein, “endorsement” is a broad term, encompassing its plain and ordinary meaning, including, but not limited to a public recommendation of an item, such as a webpage, a person, a post, an entity, etc. An endorsement may also be referred to or provided as an acknowledgment, a +1, a thumbs-up, a √ (check) mark, a confirmation, a ratification, a validation, a seal of approval, a testimonial, support, advocacy, an approval, a ratification, etc. In one embodiment, a button is provided in various web pages to enable the person to provide his or her endorsement. See for example +1 button 114.

Further, as used herein, enhanced content refers to additional information included in a social post created by the user. The enhanced content may include links to videos, audio, news, social network posts, blogs, locations, businesses, websites, ratings, etc. In general, enhanced content will include any content referenced by the user that has not been created specifically for the post by the user.

In one embodiment, a “mention” is an explicit reference to a user in an electronic message. A mention allows the creator of the post to grab someone's attention to a post because of the introduction of a mention identifier with, for example, someone's name. In one embodiment, a mention is performed by utilizing the ‘+’ or ‘ @’ signs followed by the name of a person or entity. It is noted that a “+” sign may be used to mention a person or an entity. When a person or an entity is mentioned within the context of the social network, the person or entity may receive a notification that the person or entity has been mentioned in a post (depending on notification settings). The user is also able to see the entirety of the post on which the user is mentioned, even if the post wasn't originally shared with the user.

A profile picture of the person 106 may be provided on the left side of page 102. In addition, stream filtering options 108 allows the person to limit or tune what is presented on the stream. In one embodiment, the filtering options included radio buttons to select or deselect the groups created by the person. In addition, the filtering options also include a radio button to enable or disable messages from entity pages in the stream. Although radio buttons are used, other types of user selectable controls may be used, such as drop downs, text fields, toggles, voice inputs, etc. In one embodiment, a chat button 110 is provided to allow the person to engage in conversation with others in the social network. On the right panel, icons 126 represent users in the social network that are linked with the person. In addition, the social network provides suggested new users in area 128. It is again noted that the layout of the features on the page 102 is only one example, and the layout can vary based on site designer preferences.

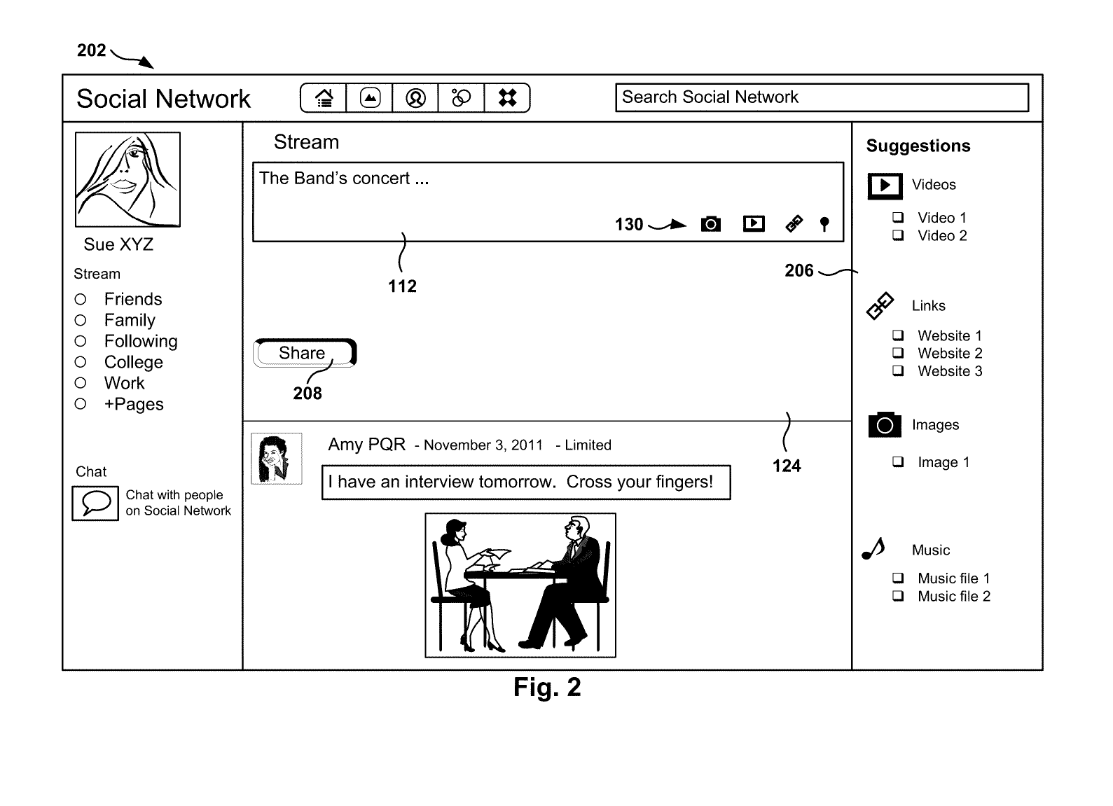

FIG. 2 is a user interface for entering a post on a social network, according to one embodiment. FIG. 2 captures a moment where the user has entered a few words for a social post, but the user has not yet committed the post. In one embodiment, the post entered by the user is committed, or posted, or completed, or submitted to the social network once the user clicks on the share button 208.

Embodiments enhance the user's experience when posting on the social network. Typically, when the user composes a post, the user enters some text, and there is an opportunity to improve the user experience by providing references to relevant materials which may be directly relevant to what the user is saying.

In one embodiment, as the user enters the text, suggestions for adding enhanced content to the social post are presented on the suggestions panel 206 situated on the right side of the webpage 202. As text is entered by the user, the system analyzes the entered text and provides suggestions that are relevant to the entered text. For example, if the user is entering a post about a concert that the user attended, suggestions may include news about the concert, a video of the musical performance or the group in the concert, images of the concert, multimedia items related to the general of the musical group (e.g., music of the 80s), etc.

In another embodiment, the suggestions are not presented until the user finishes typing or stops typing for a period of time. The system waits until there is a period of typing inactivity (e.g. one second, although other values are also possible) to present the suggestions. This way, suggestions are not presented while the user is busy typing.

In one embodiment, suggestions panel 206 includes one or more suggestions for videos, Internet links, images, music files, posts, blogs, news, etc., but other items are also possible depending on the subject or keywords of the user input. In one embodiment, only those items that are relevant to the entered text will be included in the suggestions area, which means that the type of suggestions will vary according to the entered text. If the user selects one of the suggested items (e.g., by clicking on the checkbox next to the selected item), the selected item will be included in the post together with the text entered by the user and any other items that may have also been selected by the user.

As the suggestions engine receives user selections for the presented suggestions, the suggestions engine learns from these selections, according to one embodiment. In other words, there is a positive feedback loop to incorporate the user selections as training data for enhancing the recommendations model.

In one embodiment, based on the topic-bearing keywords in the text of the post, as well as on the social network profile preferences of the user (e.g., configured interests in 80s music bands and 80s performers), the system identifies that the post relates to an 80s music group named “The Band” and relates to a concert of this music group. In response, the system provides suggestions related to the music group, music of the 80s, or even other groups similar to “The Band.” For example, based on the identified keywords and topics, the system may suggest popular videos available on the Internet for “The Band,” links to sites with information about the group, images of the group, etc.

In addition, the system may recommend social posts, created by the user or by friends of the user in the social network, that are relevant to the topic detected. Relevant photos may also be suggested, where the photos may be found in online albums of the user, albums of friends of the user, or in other Internet sites.

As the user enters more text on input box 112, the additional information allows the system to further refine the suggestions by providing better suggestions in light of the additional information received. In other words, the suggestions presented on the right side may change as more information is made available by the user.

It is noted that the embodiments illustrated in FIG. 2 are exemplary. Other embodiments may utilize different layouts on the webpage, different input methods (e.g., pop-up windows with input boxes), different types of suggestions, etc. The embodiments illustrated in FIG. 2 should therefore not be interpreted to be exclusive or limiting, but rather exemplary or illustrative.

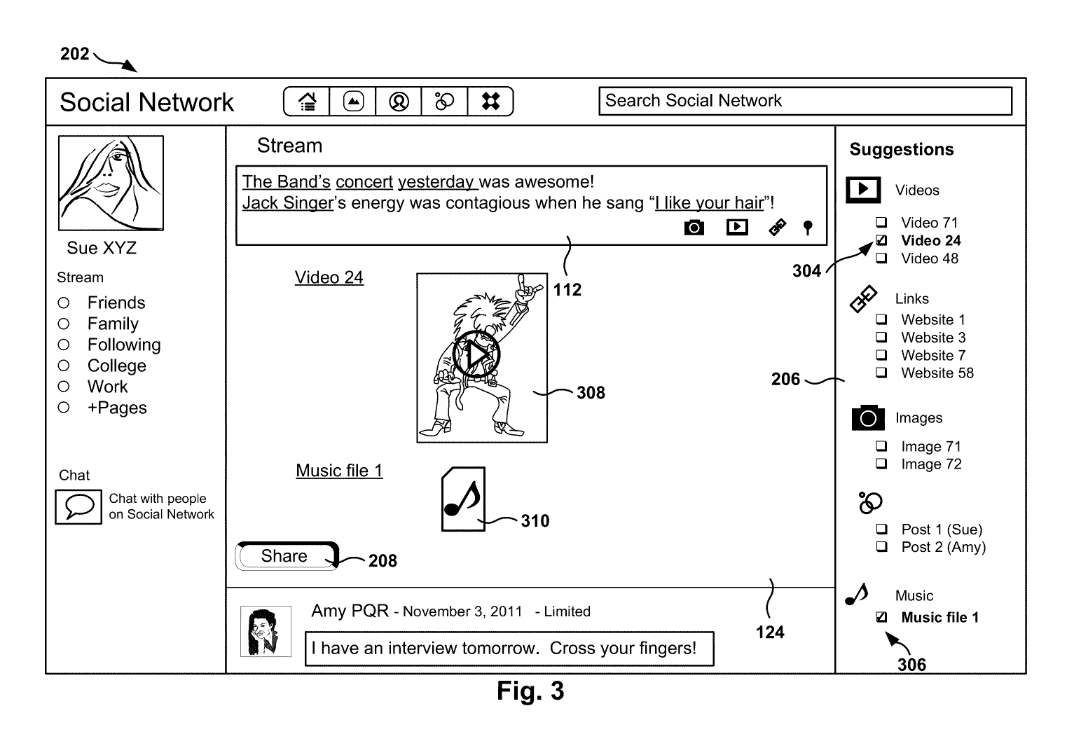

FIG. 3 illustrates a social post with enhanced content, according to one embodiment. FIG. 3 shows the webpage after the user has entered additional text for the post, but before the post has been committed. As more keywords are made available, the recommendations or suggestions change as the system has additional information to determine the content of the post. FIG. 3 also includes suggestions for posts previously created by the user (e.g., Sue) or by a friend of the user (e.g., Amy).

In the embodiment shown in FIG. 3, the user has selected video 24 (304) and music file 1 (306) to be the added to the post by checking the checkboxes next to these items. As a result of the selection, both the video 24 (308) and the music file 1 (310) are presented below the text input box 112. If the user pressed the share button 208 at this time, the post added to the social network will include the text entered in input box 112, the link to video 24, and a link to music file 1.

The posts suggested on suggestions panel 206 provides the ability to create a thread of related posts. If the user selects one of the posts, the new posts and the selected post will be linked by the social network, which provides an easy way of following the thread of related links.

In one embodiment, the selections entered by users of the social network for adding enhanced content to social posts are collected by the social network in order to provide a training mechanism for the recommendations engine. When a reference gets incorporated, the incorporation of the reference provides a stronger signal for the future incorporation of the same reference. A positive feedback loop is created to continue improving the recommendations system based on the choices made by users. This way, items that are selected more often will be presented with a higher probability by the recommendations engine.

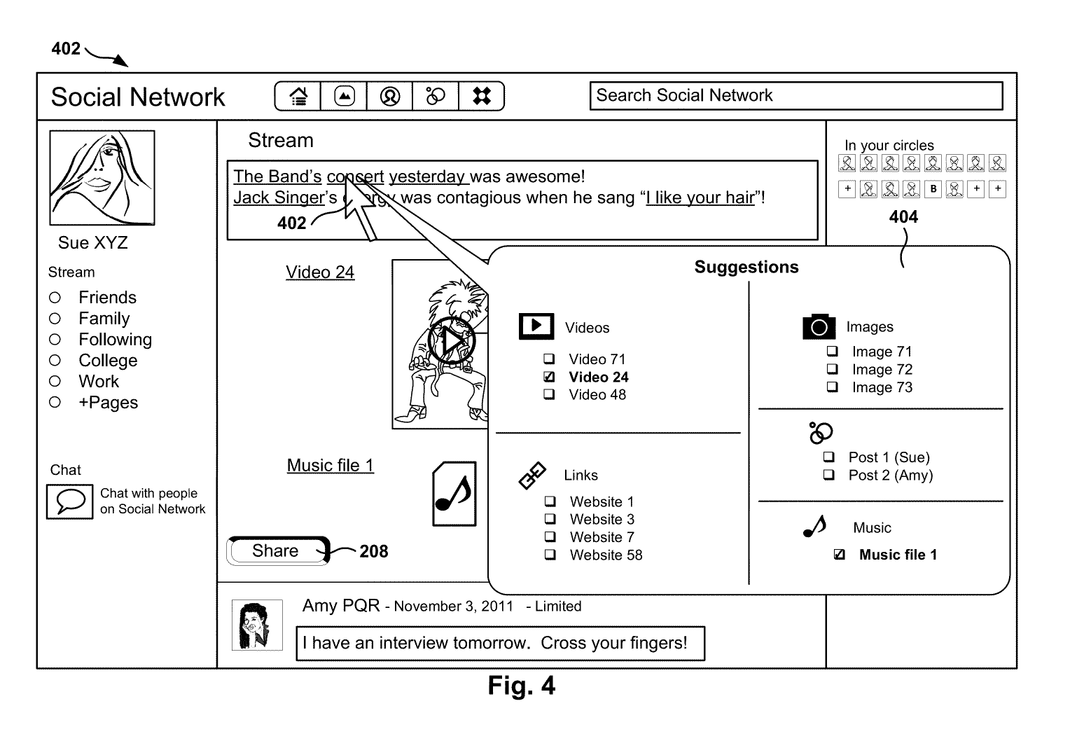

FIG. 4 shows recommendations based on a selected keyword, according to one embodiment. In one embodiment, keywords in the input text, e.g., words included in the social post that can be associated with a topic, are highlighted on the display for the user. If the user moves the mouse cursor 402 over any of the keywords (e.g., the word “concert” in the embodiment shown in FIG. 4), suggestions 404 associated with the selected keyword are presented to the user. In one embodiment, the suggestions are presented when the user clicks on one of the keywords.

As in the case when the suggestions are presented on the right panel, if the user selects one or more suggestions, the selections will be added to the post. In one embodiment, the social network provides suggestions to the user on the right panel (e.g., see FIG. 3) as well as suggestions related to keywords selected from the text entered by the user in a pop-up window. The user has the option to make selections in either of the two suggestions areas. In other embodiments, only one of the two options is provided to the user at one time.

By enabling the user to select keywords on the social post, the user may focus on the keywords of the social post, making the recommendations more relevant. In one embodiment, the recommendations are not presented to the user until the user selects one of the keywords. This way, there is less distraction to the user when the user is typing, and the suggestions are made available only when the user desires to see suggestions. In another embodiment, the option to provide suggestions can be disabled by the user, causing the system to stop making recommendations until the user changes the configuration to enable recommendations again.

In yet another embodiment, an option is provided to select the type of suggestion the user desires. For example, the user my select videos as an option and the system would only make suggestions of videos related to the topic of the social post. Of course, the user may select more than one type of multimedia for suggestions, e.g., “give me suggestions for videos and news.”

In some embodiments, a suggestion may include a map location or directions to a place. For example, if the user enters “let's meet at Joe's at 7:00” the system may add a suggestion to include a link to a map to the place mentioned in the post (e.g., Joe's Bar). In addition, the system may add a suggestion to include a link to Joe's Bar website, or a link to the menu page in Joe's Bar website.

In one embodiment, suggestions are not included until a certain threshold of relevance for the suggested items is met. This way, when the user starts typing, suggestions are omitted until there is enough information on the post for the system to identify the topic of the social post, allowing the system to provide relevant recommendations when there is enough information about the topic of the social post. As the user enters additional keywords, the recommendations server continuously recalculates the scores for candidates to be suggested items. When a few words have been entered, typically, the scores will be low as there is not yet enough information. But as additional information is entered, the topic will become clearer and the relevance scores will go higher. Once the threshold score is met by at least one of the possible candidates suggestions, the system will start providing suggestions to the user.

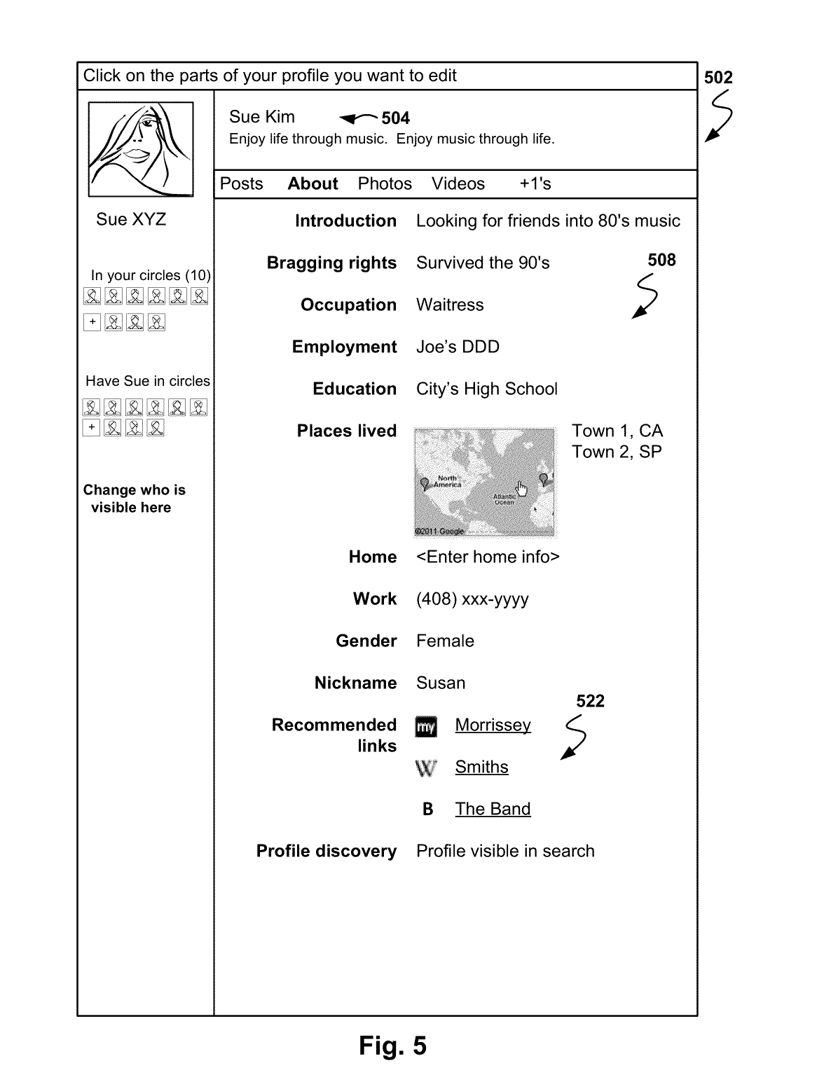

FIG. 5 is a web page 502 for entering user profile attributes, according to one embodiment. In one embodiment, one or more profile attributes are entered the first time that a user signs up the social network. Some user attributes are mandatory, such as name 504, in order to create the account. Additionally, the user has the option of adding other attributes when joining the social network, or the user may select page 502 to add or change profile attributes at a later time.

A list of user attributes is provided on entry panel 508. Next to each attribute, the current value of the attribute is presented, if the value exists. In the example of page 502, the user has and occupation of “Waitress,” has her place of employment at “Joe's DDD,” etc. When the user selects one of the attributes, an input window is presented, which provides one or more fields to the user for entering the appropriate values for the attribute. The value for an attribute may be a single item, such as age, or may include a list of values, such as “places to live.” Other attributes may include text (e.g., introduction), photos (e.g., profile photos), addresses, phone numbers, etc.

In one embodiment, an option to provide recommended links 522 is provided. The recommended links gets an indication of the interests of the user, but other types of fields might also be utilized to determine the user's interests. For example, if the user attended certain high school, activities related to the high school will be of interest to the user.

The interests of the user may be utilized by the recommendations system to evaluate and rank multimedia items that can be suggested for inclusion in the social post. Therefore, the recommendations system takes into account not only the content of the textual post, but also the interests of the user, in one embodiment.

Other embodiments may utilize different attributes, present the attributes in a different form, have different privacy options, etc. The embodiments illustrated in FIG. 5 should therefore not be interpreted to be exclusive or limiting.

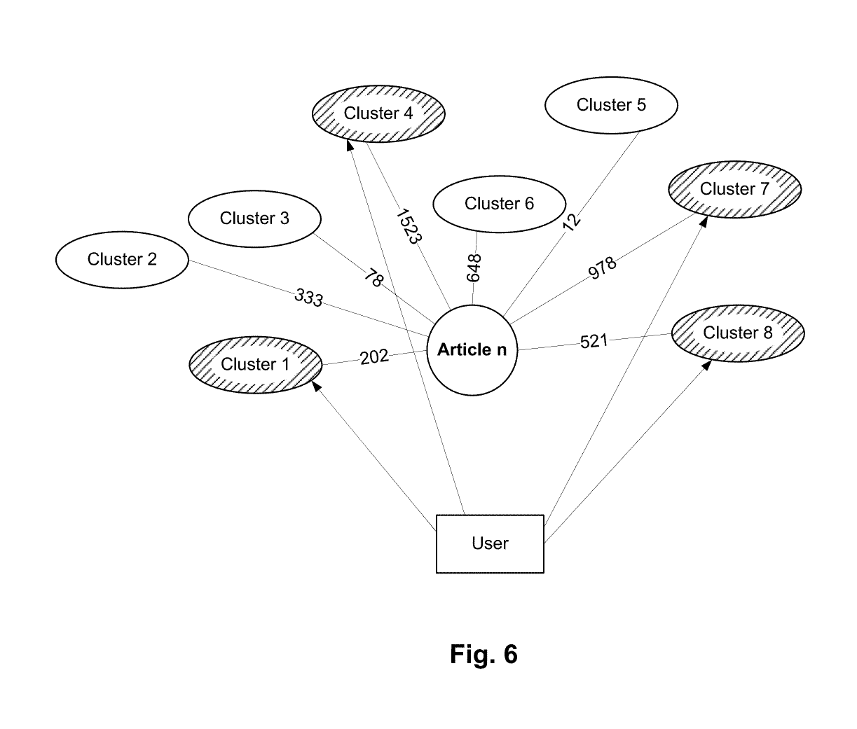

FIG. 6 illustrates a method for evaluating an article for recommendation based on cluster information, according to one embodiment. As discussed above, there are at least 2 sources of data that can be utilized for finding the best recommendations. A first source is the keywords entered by the user, where some of those keywords may be topic-bearing keywords. The second source is the user profile.

In one embodiment, the user interests and the extracted keywords are combined to score and rank materials for recommendations. The strongest signal for relevancy is where the interests and the keywords intersect. For example, if a user is interested in 80s music and the user is posting something about 80s artists, then a good source for suggestions would be videos of the 80s artists.

In one embodiment, the candidate multimedia suggestions are scored utilizing collaborative-filtering machine-learning algorithms. Collaborative filtering is a technology that aims to learn user preferences and make recommendations based on user and community data. It is a complementary technology to content-based filtering (e.g., keyword-based searching). A well-known example of collaborative filtering is when a user's past shopping history is used to make recommendations for new products. A variety of item-to-item collaborative filtering techniques can be used to implement training of the model, such as Bayes normalization (probabilistic), K-nearest neighbor (clustering), and cross-product recommendations.

The general idea in collaborative filtering is to cluster users by similarity of their interests. Based on the users' interests, users are place in clusters of interest, i.e., each cluster is associated with a topic, interest, or concept. For example, a cluster may be associated with 80s music. A user may belong to one or more clusters.

Once the clusters of users are created, each potential candidate for recommendation can be evaluated against this particular user. The goal is to determine whether a candidate item is relevant to the user and to the post. For example, if an article has been clicked a large number of times by the members of a cluster, the item will be probably relevant to the users in the cluster.

In the example of FIG. 6, the system has identified 8 different clusters, and the user belongs to 4 different clusters (represented with a shaded background in FIG. 6). The user belongs to clusters 1, 4, 7, and 8, and the user does not belong to clusters 2, 3, 5, and 6.

A certain Article n is being evaluated by the recommendations system. FIG. 6 shows how many times this Article n has been clicked (e.g., selected) by users in each cluster in the line that joins the circle representing Article n with the respective clusters. For example, members of cluster 1 have clicked Article n 202 times, cluster 2 has clicked Article n 333 times, etc.

In one embodiment, two connections are identified: the user belongs to clusters, and the clusters related to the article in a certain way (e.g. number of clicks). The number of clicks gives a relative weight of the value provided by each of the clusters towards the article.

In one embodiment, the weights for ranking the articles are based on the number of clicks for each cluster. Therefore, there are two types of weights. The first set of weights is based on the number of clicks per cluster. The second set of weights is based on a cluster belong-to relationship, where clusters that include the user will be given more weight than clusters that do not include the user.

In addition, weights may also be assigned to posts that are related to the writer or to friends of the writer. For example, the score is weighted, in one embodiment, based on circle membership.

In another embodiment, a time component is included, where older clicks have less weight than more recent clicks. In other words, the click count decays over time (unless of course, users in the cluster add more clicks). This means that older items are less relevant than more recent articles. In one embodiment, a higher relevance score is given to candidate items that are more recent than older candidate items.

As discussed above with reference to FIGS. 2-4, in one embodiment, as the user types the list of potential articles is dynamically constructed. As more information is made available, the list of recommendations is adjusted. The entered keywords are sent to the analysis engine in order to continue updating the list of recommendations.

It is noted that the embodiments illustrated in FIG. 6 are exemplary. Other embodiments may utilize different methods for ranking articles, such as be just popularity of the item, or just by clusters including the user, by date of creation of the article, etc. The embodiments illustrated in FIG. 6 should therefore not be interpreted to be exclusive or limiting, but rather exemplary or illustrative.

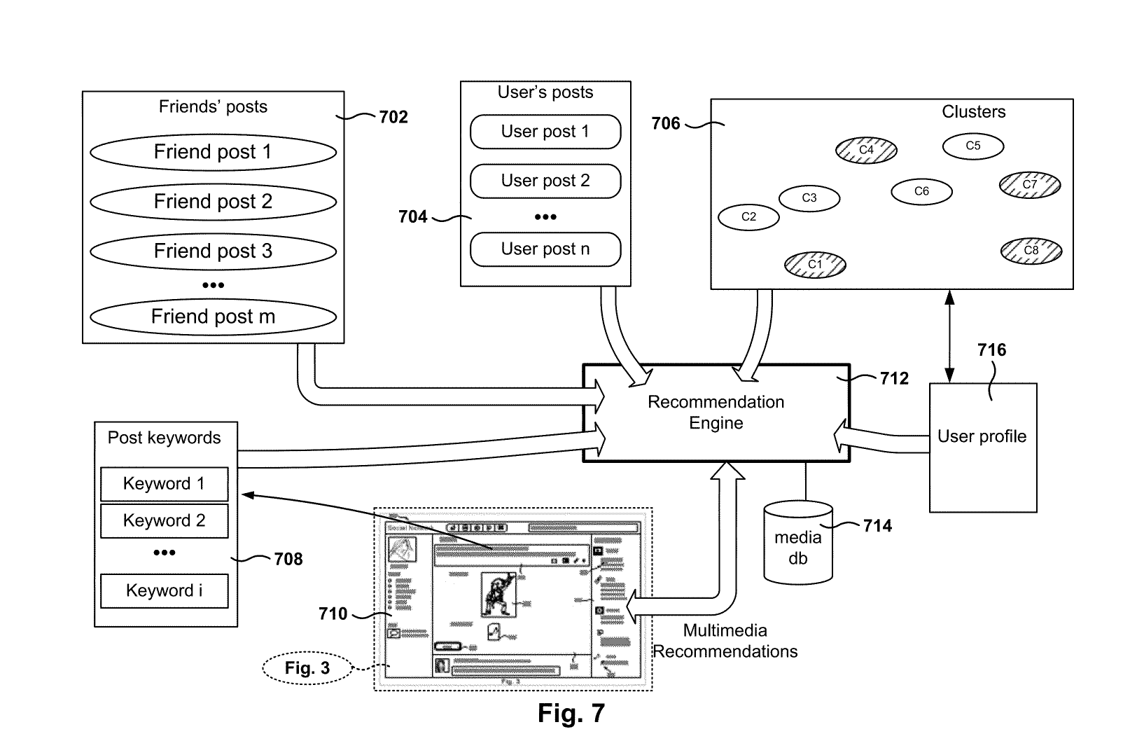

FIG. 7 illustrates the method for generating recommendations, according to one embodiment. As the user enters the social post, the recommendation engine 712 dynamically generates suggestions for multimedia content that can be added to the social post by the user. As discussed above, the recommendations are presented to the user to allow the user to select one or more of the recommended items.

The inputs for the recommendation engine 712 include the keywords in the post 708, posts 704 created by the user, posts 702 created by friends of the user, and social network information, such as clusters of interest 706 and user profile 716. The recommendation engine 712 scores multimedia items available in database 714 for possible recommendation. It is noted that the multimedia database 714 may include some multimedia items, but the multimedia database 714 does not necessarily include all possible recommendations because the multimedia database 714 but may also include links to where the recommended items may be found on the network.

In one embodiment, keywords 708 include those words that include a topical value. The recommendation engine 712 utilizes the topic identified by the keywords to formulate recommendations. See for example the description with reference to FIG. 6 above. In addition, clustering information is utilized to provide a score for the possible candidates for recommendation.

The posts entered by the user in the social network 704 serve a dual role. On one hand, the post entered by the user help identify the interests of the user (besides those interests already identified on the user profile). And on the other hand, the posts entered by the user may be included as recommendations. Similarly, friends' posts may be utilized to identify topics of interest to the user, as well as being candidates for recommendations.

Clusters 706 are utilized by the recommendations engine 712, in one embodiment, to implement collaborative filtering in order to identify items that are more popular on the network. More specifically, to identify items that are popular in those clusters that include the user. In addition, user profile 716 provides information regarding the topics of interest for the user.

It is noted that the embodiments illustrated in FIG. 7 are exemplary. Other embodiments may utilize different inputs, outputs, a subset of inputs, provide recommendations in a limited set of categories (e.g. user posts), etc. The embodiments illustrated in FIG. 7 should therefore not be interpreted to be exclusive or limiting, but rather exemplary or illustrative.

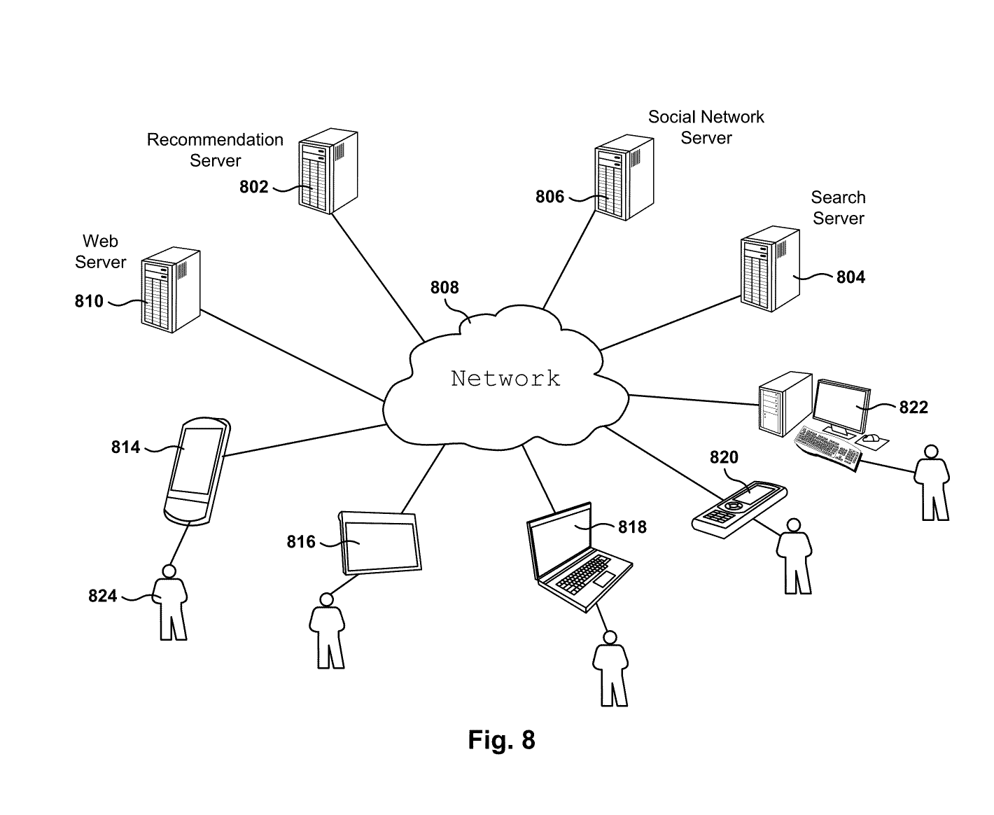

FIG. 8 provides an architecture of a system that may utilize embodiments described herein. Users 824 interact with each other in the context of a social network, where users include people and entities. Each user has an account in the social network, and the account includes at least a user name. In addition, each account includes a profile of the user with additional information about the user, e.g., residence, favorite activities, interests, etc. The user is in control of what information is added to the profile, and what information is shared with others. A user may access the social network through different devices e.g., a smart phone 814, a tablet computer 816, a laptop 818, a mobile phone 820, a personal computer 822, a television with one or more processors embedded therein and/or coupled thereto (not pictured), or any computing device that provides access to the Internet. Of course, the illustrated devices are only examples.

In some embodiments, social network server 806 delivers services that enable users to interface with each other. The social network provides a site that enables users to define user accounts, which can be accounts for people and entity accounts. Through those accounts, users are able to connect with their friends, group of friends, entities, groups of entities, etc. In some embodiments, the relationships established in the social network may be utilized in other contexts and websites. Search server 804 provides Internet search capabilities.

Recommendation server 802 provides recommendations or suggestions for relevant multimedia items that can be added to social posts, as the social posts are being created by users. Recommendation server 802 interfaces with web server 810, social network server 806, search server 804, and client devices to perform post-creation operations.

In some embodiments, the social network provides entities with a specific type of interface for posting messages, communicating, sharing, and generally interacting within the social network. In some embodiments, this interface for entities is referred to as “plus pages,” indicated by a token, e.g., “+”, followed by the name of the entity in the social network (e.g., Acme corporation has a “+Acme” page). Real-persons have “person pages,” which are different from plus pages and have different functionality, although some features are common to both plus pages and person pages. Although the symbol “+” and word “plus” is referred to herein as denoting a type of site or place within the social network, it should be appreciated that any symbol, identifier, word, or character may be used to define or identify the social services. In an alternate embodiment, the services can be provided without the use of any special symbols or denoted nomenclature. Thus, so long as the social network site provides the functionality defined herein, the nomenclature utilized to denote the services can take on any form, format or identifier.

Other embodiments may utilize different servers, have the functionality of one server distributed over a plurality of servers, have the functionality of two or more servers combined into a single server, have a different amount of display categories in the social network, prioritize user posts with different criteria, provide different options for adding multimedia content, etc. The embodiments illustrated in FIG. 8 should therefore not be interpreted to be exclusive or limiting, but rather illustrative.

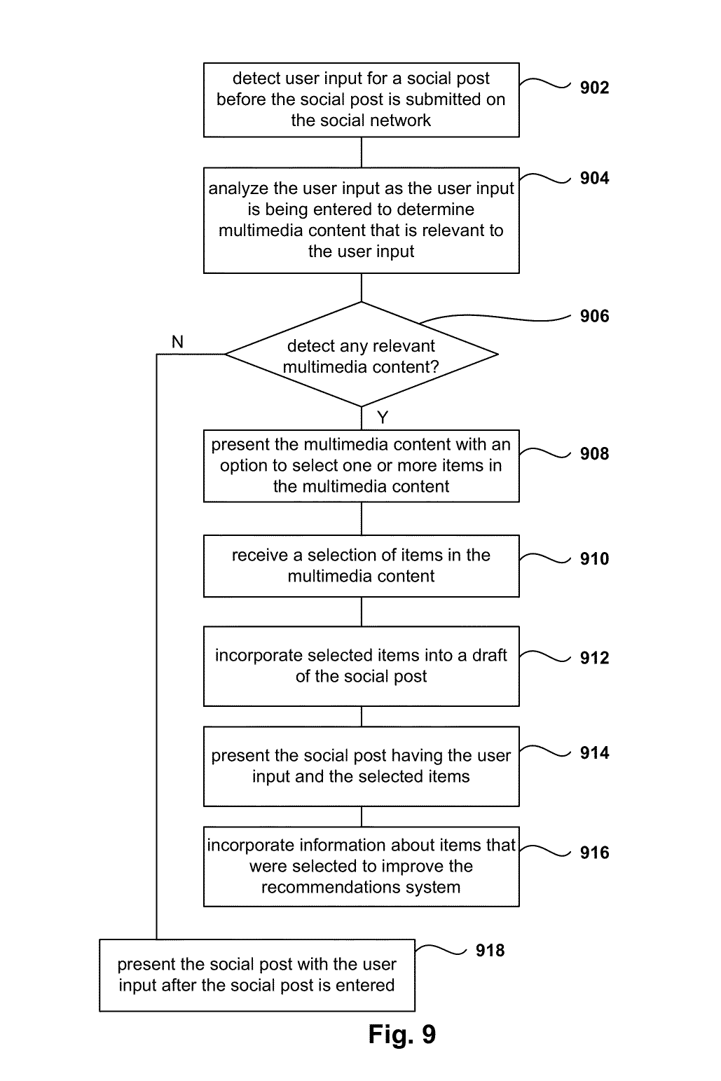

FIG. 9 shows a flowchart illustrating a process for creating a social post in a social network, in accordance with one embodiment. In operation 902, user input is detected, the input being for a social post (see for example input in box 112 of FIG. 2). The detection takes place before the social post is posted on the social network, e.g., as the user is entering the social post, but before the social post is committed or submitted. From operation 902, the method flows to operation 904 where the user input is analyzed, as the user input is being entered, to determine multimedia content that is relevant to the user input (see for example suggestions 206 of FIG. 2, suggestions 404 of FIG. 4, and recommendation engine 712 of FIG. 7).

In operation 906, a check is made to determine if multimedia content relevant to the user input is available to provide suggestions to the user for adding multimedia content items in the social post being created. If the check in operation 906 determines that there is relevant multimedia content, the method continues to operation 908, and to operation 918 otherwise.

In operation 908, the multimedia content is presented with an option to select one or more items in the multimedia content (see for example suggestions 206 of FIG. 2 and suggestions 404 of FIG. 4) to. From operation 908, the method continues to operation 910 where a selection of items in the multimedia content are received (see checkmarks entered by user in the suggestions referenced above). The selection may include one or more items of the multimedia content, which may include videos, Internet links, images, music files, computer files, posts on the social network, etc.

From operation 910, the method continues to operation 912 where the items selected in operation 910 are incorporated into a draft of the social post (see for example video 308 and music file 310 of FIG. 3). Further, in operation 914 the social post is presented. The social post includes the user input and the selected items (if any). If no relevant content has been suggested for addition to the user (or if the user has not selected any of the suggested multimedia content), in operation 918, the social post is presented, where the social post includes the user input without any other enhance multimedia content. One or more operations of the method are executed through a processor.

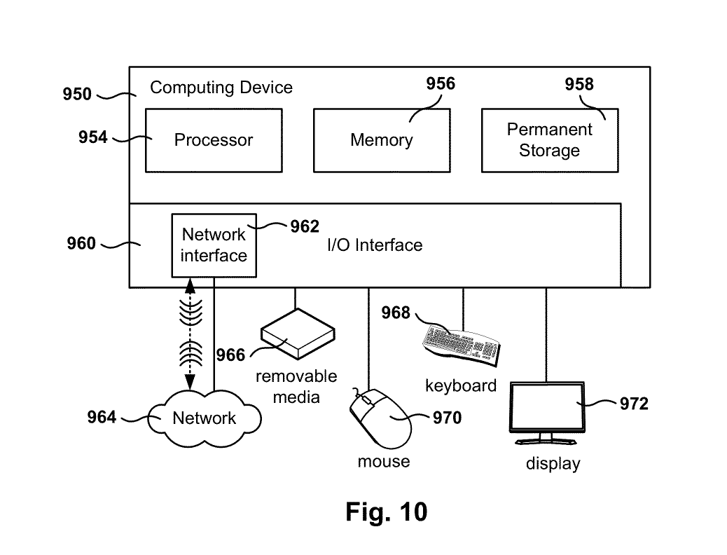

FIG. 10 is a schematic diagram of a computer system for implementing embodiments described herein. It should be appreciated that the methods described herein may be performed with a digital processing system, e.g., a conventional, general-purpose computer system. Special purpose computers, which are designed or programmed to perform only one function, may be used in the alternative. The computing device 950 includes a processor 954, which is coupled through a bus to memory 956, permanent storage 958, and Input/Output (I/O) interface 960.

Permanent storage 958 represents a persistent data storage device e.g., a hard drive or a USB drive, which may be local or remote. Network interface 962 provides connections via network 964, allowing the exchange of electronic messages (wired or wireless) with other devices. It should be appreciated that processor 954 may be embodied in a general-purpose processor, a special purpose processor, or a specially programmed logic device. Input/Output (I/O) interface 960 provides communication with different peripherals and is connected with processor 954, memory 956, and permanent storage 958, through the bus. Sample peripherals include display 972, keyboard 968, mouse 970, removable media device 966, etc.

Display 972 is configured to display the user interfaces described herein. Keyboard 968, mouse 970, removable media device 966, and other peripherals are coupled to I/O interface 960 in order to exchange information with processor 954. It should be appreciated that data to and from external devices may be communicated through I/O interface 960. Embodiments can also be practiced in distributed computing environments where tasks are performed by remote processing devices that are linked through a wired or a wireless network.

Embodiments can be fabricated as computer readable code on a non-transitory computer readable storage medium. The non-transitory computer readable storage medium holds data which can be read by a computer system. Examples of the non-transitory computer readable storage medium include permanent storage 958, network attached storage (NAS), read-only memory or random-access memory in memory module 956, Compact Discs (CD), Blu-Ray™ discs, flash drives, hard drives, magnetic tapes, and other data storage devices. The non-transitory computer readable storage medium may be distributed over a network-coupled computer system so that the computer readable code is stored and executed in a distributed fashion.

Some, or all operations of the method presented herein are executed through a processor, e.g., processor 954 of FIG. 10. Additionally, although the method operations were described in a specific order, it should be understood that some operations may be performed in a different order, when the order of the operations do not affect the expected results. In addition, other operations may be included in the methods presented, and the operations may be performed by different entities in a distributed fashion, as long as the processing of the operations is performed in the desired way.

In addition, at least one operation of some methods performs physical manipulation of physical quantities, and some of the operations described herein are useful machine operations. Embodiments presented herein recite a device or apparatus. The apparatus may be specially constructed for the required purpose or may be a general purpose computer. The apparatus includes a processor capable of executing the program instructions of the computer programs presented herein.

Although the foregoing embodiments have been described with a certain level of detail for purposes of clarity, it is noted that certain changes and modifications can be practiced within the scope of the appended claims. Accordingly, the provided embodiments are to be considered illustrative and not restrictive, not limited by the details presented herein, and may be modified within the scope and equivalents of the appended claims.

What is claimed is:

1. A method comprising:
detecting, using one or more computing devices, text entered by a user as user input for a social post before the social post is submitted on the social network;
analyzing, using the one or more computing devices, the text entered as the text is being entered to determine content that is relevant to the text;
providing for display, using the one or more computing devices, the content with an option to select one or more items in the content for inclusion in the social post, wherein the content is based on the text entered by the user;
receiving, using the one or more computing devices, a selection of items in the content for inclusion in the social post; and
providing for display, using the one or more computing devices, the social post having the user input and the selected items in the content.

2. The method of claim 1, wherein analyzing the text entered further comprising:
analyzing the text entered as the text is being entered to determine multimedia content that is relevant to the text entered.

3. The method of claim 1, wherein detecting the text entered further comprising:
determining which words in the user input are associated with topics; and
utilizing the topics for determining relevance of the content to determine content priority for display.

4. The method of claim 1, wherein analyzing the text entered further comprising:
determining which posts of a user entering the user input are relevant to the user input.

5. The method of claim 1, wherein analyzing the text entered further comprising:
determining which posts in a stream of a user entering the user input are relevant to the user input.

6. The method of claim 1, wherein analyzing the text entered further comprising:
identifying topics associated with words entered in the text;
identifying a cluster of users with similar interests for each topic; and
ranking candidate items of content based on how many times users within each cluster have selected the candidate items.

7. The method of claim 1, wherein analyzing the text entered further comprising:
determining if candidate items of content are related to interests of a user entering the user input.

8. The method of claim 1, wherein analyzing the text entered further comprising:
determining how many times candidate items of content have been posted on the social network.

9. The method of claim 1, wherein providing for display the content further comprising:
presenting the content when a threshold score of relevance is reached for at least one item of the content.

10. The method of claim 1, wherein items in the content are selected from a group consisting of video, audio, image, a textual post from another social network user, content from a website, or a link to a website.

11. The method of claim 1, wherein providing for display the content further comprising:
providing a selection box next to each item in the content for adding the respective item to the social post.

12. A non-transitory computer-readable storage medium including instructions that when executed by one or more processors, cause the one or more processors to perform operations comprising:
detecting text entered by a user as user input for a social post before the social post is submitted on the social network;
analyzing the text entered as the text is being entered to determine multimedia content that is relevant to the text;
providing for display the multimedia content with an option to select one or more items in the multimedia content for inclusion in the social post, wherein the content is based on the text entered by the user;
receiving a selection of items in the multimedia content for inclusion in the social post; and
providing for display the social post having the user input and the selected items in the content.

13. The non-transitory computer readable storage medium of claim 12, wherein analyzing the text entered, the operations further comprising:
providing a higher relevance score based on a creation time of a candidate item for the multimedia content.

14. The non-transitory computer readable storage medium of claim 12, wherein analyzing the text entered, the operations further comprising:
providing a higher relevance score based on an age of user clicks of a candidate item for the multimedia content.

15. The non-transitory computer readable storage medium of claim 12, wherein detecting text entered by a user as user input, the operations further comprising:
determining which words are associated with topics; and
utilizing the topics for determining relevance of the multimedia content.

16. The non-transitory computer readable storage medium of claim 12, wherein analyzing the text entered, the program instructions further comprising:
determining which posts of a user entering the user input are relevant to the user input.

17. The non-transitory computer readable storage medium of claim 12, the program instructions further comprising:
incorporating information about the selection of items to improve a system for generating recommendations.

18. A method comprising:
detecting, using one or more computing devices, text entered by a user as user input for a social post before the social post is submitted on the social network, wherein the text includes one or more topic-bearing keywords having topical meaning;
analyzing, using the one or more computing devices, the topic-bearing keywords as the user input is being entered to determine content that is relevant to the topic-bearing keywords;
providing for display, using the one or more computing devices, the content with an option to select one or more items in the content for inclusion in the social post, wherein the content is based on the text entered by the user;
receiving, using the one or more computing devices, a selection of items in the content for inclusion in the social post; and
providing for display, using the one or more computing devices, the social post having the user input and the selected items in the content, wherein operations of the method are executed through a processor.

19. The method of claim 18, wherein presenting the content further comprising:
presenting the topic-bearing keywords in a format different from a format for words that are not topic-bearing keywords.

20. The method of claim 19, further comprising:
presenting content related to a topic-bearing keyword when a user moves a mouse cursor over the topic-bearing keyword.

21. The method of claim 18, further comprising:
changing the content provided for display as a user enters additional text.
